(19) United States
(12) Patent Application Publication
(10) Pub. No.: US 2024/0399796 A1
(43) Pub. Date: Dec. 5, 2024

(54) THREE-DIMENSIONAL TIRE SIPE

(71) Applicant: BRIDGESTONE AMERICAS TIRE OPERATIONS, LLC, Nashville, TN (US)

(72) Inventors: Matthew A. Irwin, Medina, OH (US); Kevin J. Kosmac, Fairlawn, OH (US); Daisuke Nakahara, Copley, OH (US)

(73) Assignee: BRIDGESTONE AMERICAS TIRE OPERATIONS, LLC, Nashville, TN (US)

(21) Appl. No.: 18/698,556

(22) PCT Filed: Sep. 27, 2022
(86) PCT No.: PCT/US2022/077051

§ 371 Date: Apr. 4, 2024

Related U.S. Application Data
(60) Provisional application No. 63/252,444, filed on Oct. 5, 2021.

(51) Int. Cl. B60C 11/12

(52) U.S. Cl. CPC B60C 11/1218; B60C 2011/1213

(57) ABSTRACT

Various embodiments of a tire having a three-dimensional tire sipe are disclosed. In one embodiment, a tire having a sipe is provided, the tire comprising: opposing tread element portions separated by the sipe, each opposing tread element portion including a plurality of positive elements and a plurality of negative elements, wherein the plurality of positive elements and the plurality of negative elements include three substantially quadrilateral-shaped planar surfaces, each planar surface being oriented relative to another planar surface by an angle of 90 degrees, wherein the three planar surfaces meet at a rounded terminal portion, wherein the sipe includes a radially outer zig-zag portion, wherein the sipe includes a radially inner three-dimensional portion radially inward of the radially outer zig-zag portion, and wherein the sipe includes a radially inner zig-zag portion radially inward of the radially inner three-dimensional portion.

### CROSS-REFERENCE TO RELATED APPLICATIONS

This application claims priority from U.S. Provisional Patent Application No. 63/252,444 filed on Oct. 5, 2021, which is incorporated by reference herein in its entirety.

### BACKGROUND

Tires for use on vehicles may comprise a tread featuring sipes. The presence of sipes in a tire tread may create more surface edges to engage a roadway, which may increase traction in adverse road conditions. For example, a tire tread including sipes may perform better in icy, snowy, or wet road conditions than a tire tread not including sipes. Likewise, the more sipes a tire has, the better traction it may exhibit in adverse road conditions.

However, the addition of sipes to a tire tread block may reduce block stiffness, which may result in undesirable irregular wear patterns in the tire and a decrease in tire performance in dry road conditions (i.e., non-adverse conditions). Increasing the number of sipes in a tire tread block may relate to a decrease in stiffness of that tire tread block.

Additionally, sipe blades used to form sipes having the desired traction while maintaining the desired block stiffness may be difficult to draw out of a tire after molding and curing (tire mold extraction). Thus, it may be desirable to reduce the undercut surface geometry of the sipe blade to reduce the force necessary to extract the mold from the cured tire.

What is needed is a tire sipe configured to provide adequate traction in adverse road conditions, while maintaining the required stiffness for dry road conditions and resisting irregular wear patterns, and while reducing the force necessary to extract the mold from the cured tire.

### SUMMARY

In one embodiment, a tire having a sipe is provided, the tire comprising: opposing tread element portions separated by the sipe, each opposing tread element portion including a plurality of positive elements and a plurality of negative elements, wherein the plurality of positive elements and the plurality of negative elements include three substantially quadrilateral-shaped planar surfaces, each planar surface being oriented relative to another planar surface by an angle of 90 degrees, wherein the three planar surfaces meet at a rounded terminal portion, wherein the sipe includes a radially outer zig-zag portion, wherein the sipe includes a radially inner three-dimensional portion radially inward of the radially outer zig-zag portion, and wherein the sipe includes a radially inner zig-zag portion radially inward of the radially inner three-dimensional portion.

In another embodiment, a tire having a sipe is provided, the tire comprising: opposing tread element portions separated by the sipe, each opposing tread element portion including a plurality of positive elements and a plurality of negative elements, wherein the plurality of positive elements and the plurality of negative elements include three substantially quadrilateral-shaped planar surfaces, each planar surface being oriented relative to another planar surface by an angle of 90 degrees, wherein the three planar surfaces meet at a rounded terminal portion, wherein the sipe includes a radially outer zig-zag portion, wherein the sipe includes a radially inner three-dimensional portion radially inward of the radially outer zig-zag portion, and wherein the sipe includes a radially inner zig-zag portion radially inward of the radially inner three-dimensional portion, the radially inner zig-zag portion including radially-extended peaks and valleys.

### BRIEF DESCRIPTION OF THE DRAWINGS

The accompanying figures, which are incorporated in and constitute a part of the specification, illustrate various example configurations, and are used merely to illustrate various example embodiments. In the figures, like elements bear like reference numerals.

FIG. 1A illustrates an elevation view of a prior art sipe blade 100 for forming a three-dimensional tire sipe.

FIG. 1B illustrates a sectional view of a prior art sipe blade 100 for forming a three-dimensional tire sipe.

FIG. 2A illustrates an elevation view of an example sipe blade 200 for forming a three-dimensional tire sipe.

FIG. 2B illustrates a perspective view of example sipe blade 200 for forming a three-dimensional tire sipe.

FIG. 2C illustrates an elevation view of example sipe blade 200 for forming a three-dimensional tire sipe.

FIG. 2D illustrates a plan view of example sipe blade 200 for forming a three-dimensional tire sipe.

FIG. 3 illustrates a plan view of a tire tread element 334 illustrating engagement between a first and second element of a three-dimensional tire sipe.

### DETAILED DESCRIPTION

Tires not intended for operation on smooth, dry surfaces typically comprise a tread pattern, including a least one groove, at least one rib, and/or a plurality of tread blocks. Tires intended for operation in inclement conditions, including for example icy or snowy conditions, may additionally comprise a plurality of sipes in the tire tread. The addition of sipes in the tire tread may result in more surface edges in the tire tread for engagement with the icy or snowy roadway.

Increasing the length of a sipe, such as providing the sipe with a three-dimensional pattern, may increase the amount of cutting edges available to engage snowy, icy, and/or wet road surfaces.

Providing the sipe with a three-dimensional pattern in at least one of the lateral direction of the tire and the radial direction of the tire, may allow opposing walls of the sipe to at least partially engage one another in a high friction, or locking, manner to maintain a desired stiffness of the tire tread block or tire tread rib. Maintaining a specified level of stiffness in the tire tread may mitigate or eliminate irregular wear patterns. Maintaining a specified level of stiffness in the tire tread may improve stopping distance of the tire. Maintaining a specified level of stiffness in the tire tread may improve traction of the tire.

However, sipe blades used to form sipes having the desired traction while maintaining the desired block stiffness may be difficult to draw out of a tire after molding and curing (tire mold extraction). This results from the amount of surface area of the sipe blade at its distal portion, which forms the radially innermost portion of the tire after molding and curing.

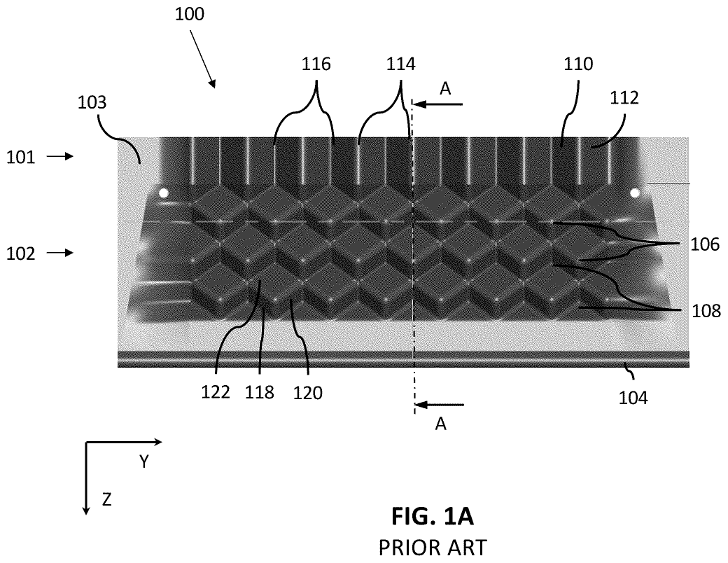

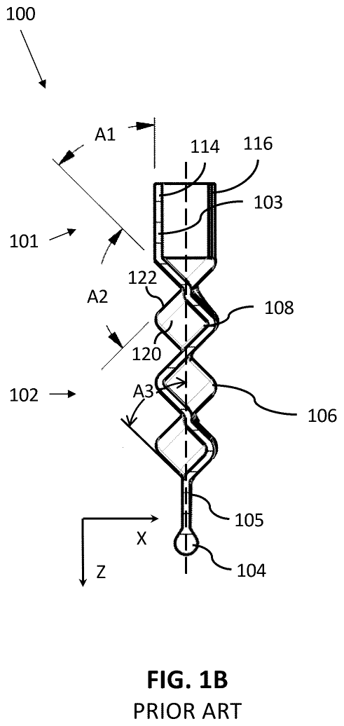

FIG. 1A illustrates a prior art sipe blade 100 for forming a three-dimensional tire sipe. Blade 100 may include a radially outer zig-zag portion 101, and a radially inner three-dimensional portion 102. Blade 100 may include a central plane 103, and a base 104.

Blade 100 may be used in conjunction with a mold to mold a three-dimensional sipe into a tire. The use of blade 100 results in the creation of a negative of blade 100 being formed in a sipe of a tire, creating the three-dimensional sipe.

Blade 100 is formed using a thin sheet of material pressed into a desired shape, and generally having a material thickness that is consistent at least through radially outer zig-zag portion 101 and radially inner three-dimensional portion 102. In this manner, it is understood that a feature that is positive (i.e., extending out of blade 100 on a first side of blade 100) is negative (i.e., extending into blade 100 on a second side of blade 100).

It is understood that when molding a tire using a sipe blade, such as blade 100 (and all other blades described below), base 104 forms the base of a sipe in a tire, while radially outer zig-zag portion would form the ground-contacting radially outer portion of the sipe. Blade 100 may be affixed into a tire mold in such a manner to effect this molding orientation. As such, the term “radially outer zig-zag portion” reflects the fact that a three-dimensional sipe molded into a tire using blade 100 (and all other blades described below) would include the zig-zag feature molded by radially outer zig-zag portion 101 in a portion of the three-dimensional sipe that is oriented radially outward relative to the remainder of the three-dimensional sipe. Similarly, the term “radially inner three-dimensional portion” reflects the fact that a three-dimensional sipe molded into a tire using blade 100 (and all other blades described below) would include the three-dimensional feature molded by radially inner three-dimensional portion 102 in a portion of the three-dimensional sipe that is oriented radially inward relative to radially outer zig-zag portion 101.

The X, Y, and Z axes illustrated in the figures are utilized for ease of description of the invention, and are not intended as limiting. In some instances, the X-axis may be generally tangential to the circumferential direction of a tire, the Y-axis may be generally parallel to the axial direction of a tire, and the Z-axis may be generally parallel to the radial direction of a tire. In some instances, the X-axis may be exactly tangential to the circumferential direction of a tire, the Y-axis may be exactly parallel to the axial direction of a tire, and the Z-axis may be exactly parallel to the radial direction of a tire.

Blade 100 may include a plurality of positive elements 106 and a plurality of negative elements 108. Collectively, these features may form the three-dimensional feature described herein. That is, a pattern of alternating positive elements 106 and negative elements 108 may form the three-dimensional feature described as radially inner three-dimensional portion 102.

Positive elements 106 and negative elements 108 may result in corresponding positive elements and negative elements in a three-dimensional tire sipe molded using blade 100. These corresponding positive elements and negative elements may interlock with one another so as to create stiffness in a tire tread element having the three-dimensional sipe. The corresponding features may come together along the X-axis, to provide greater shear strength in the Y-Z plane between opposing faces of a sipe, as compared to a traditional, straight wall sipe.

Radially outer zig-zag portion 101 may be formed by a series of alternating angled surfaces 110 and 112, which form radially-extending peaks 114 and valleys 116. These peaks and valleys may form corresponding peaks and valleys in a tire sipe molded using blade 100. These corresponding peaks and valleys may interlock with one another so as to create stiffness in a tire tread element having the three-dimensional sipe.

Each of the three-dimensional features forming the plurality of positive elements 106 and a plurality of negative elements 108 may be made up of three planar surfaces 118, 120, and 122. Each of planar surfaces 118, 120, and 122 may be angled relative to one another by about 90 degrees. The point at which each of planar surfaces 118, 120, and 122 meet may be a rounded, terminal portion. Each of planar surfaces 118, 120, and 122 may have a quadrilateral shape.

Sipe blade 100 may be difficult to draw out of a tire after molding and curing (tire mold extraction). This results from the amount of surface area of the sipe blade at its distal portion (the radially inner three-dimensional portion 102).

FIG. 1B illustrates a sectional view of an example sipe blade 100 for forming a three-dimensional tire sipe. FIG. 1B represents a sectional view taken about line A-A in FIG. 1A.

Sipe blade 100 may include a radially outer zig-zag portion 101, and a radially inner three-dimensional portion 102. Blade 100 may include a central plane 103, and a base 104.

Blade 100 may include a plurality of positive elements 106 and negative elements 108. The plurality of positive elements 106 and negative elements 108 may be made up planar surfaces 118, 120, and 122. Blade 100 may include a plurality of valleys 116 and peaks 114 oriented in the radially outer zig-zag portion 101.

In one embodiment, central plane 103 bisects the plurality of positive elements 106 and negative elements 108.

The line formed by the intersection of planar surfaces 118 and 120 may be oriented at an angle A1 relative to peak 114 (and central plane 103). Angle A1 may be about 45 degrees. Angle A1 may be 45 degrees.

The line formed by the intersection of planar surfaces 118 and 120 may be oriented at an angle A2 relative to planar surface 122 (forming the top surface). Angle A2 may be about 90 degrees. Angle A2 may be 90 degrees.

The line formed by the intersection of planar surfaces 118 and 120 may be oriented at an angle A3 relative to a radial connection 105 extending between radially inner three-dimensional portion 102 and base 104. Angle A3 may be about 45 degrees. Angle A3 may be 45 degrees. Radial connection 105 is planar, oriented between base 104 and radially inner three-dimensional portion 102. That is, the lower row of positive elements 106 and negative elements 108 terminates, and radial connection 105 begins, extending to base 104. Radial connection 105 being planar is intended to mean that it has a flat shape, devoid of significant variation, and a substantially constant thickness, excepting a localized transition to base 104 and the lower row of positive elements 106 and negative elements 108.

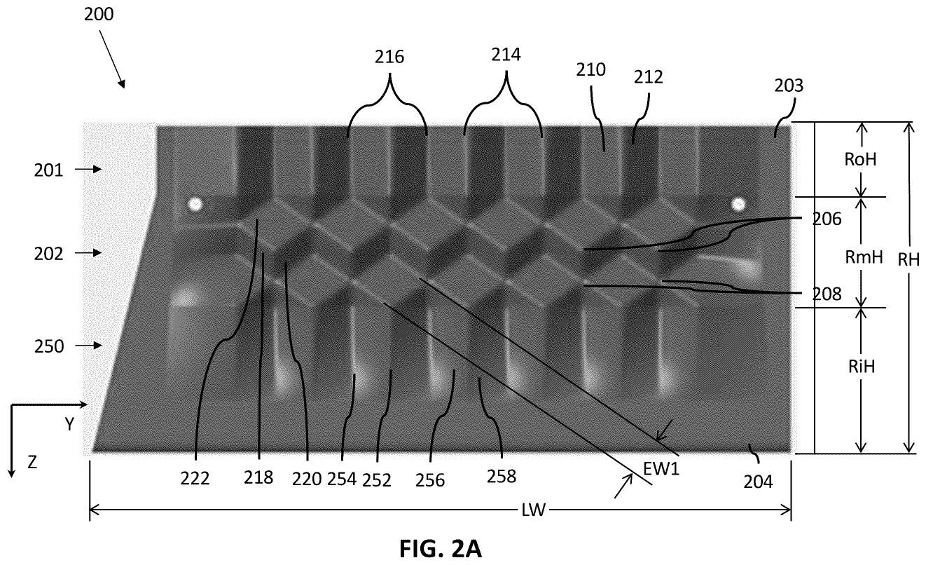

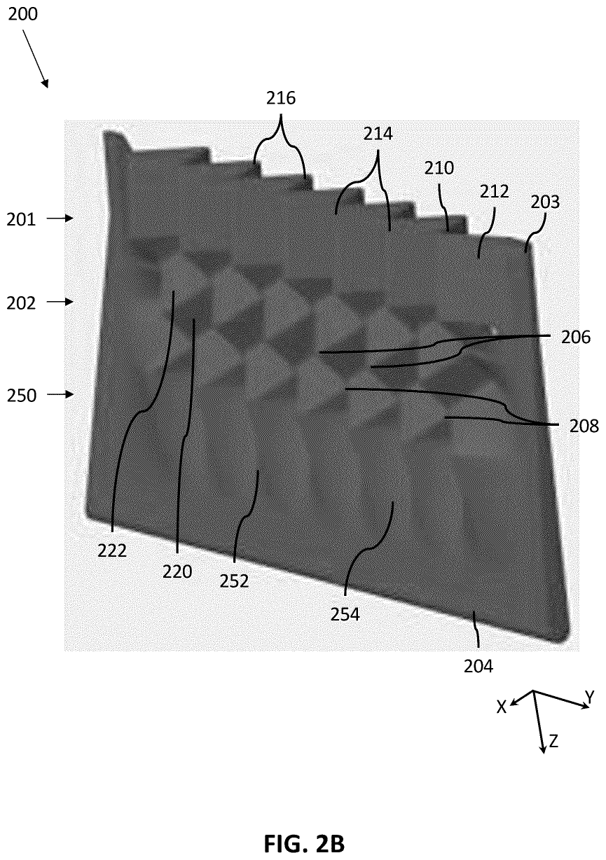

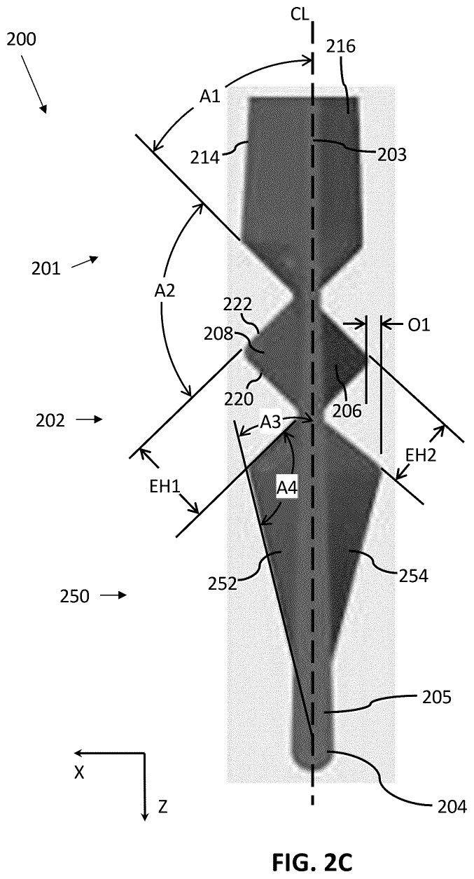

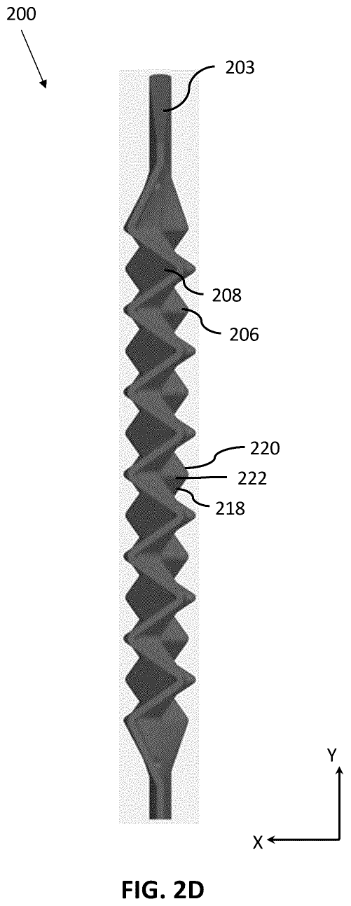

FIGS. 2A-2D illustrates an example sipe blade 200 for forming a three-dimensional tire sipe. Blade 200 may include a radially outer zig-zag portion 201, a radially inner three-dimensional portion 202, and a radially inner zig-zag portion 250. Radially inner three-dimensional portion 202 is oriented radially between radially outer zig-zag portion 201 and radially inner zig-zag portion 250. Blade 200 may include a central plane 203, and a base 204.

Blade 200 may be used in conjunction with a mold to mold a three-dimensional sipe into a tire. The use of blade 200 results in the creation of a negative of blade 200 being formed in a sipe of a tire, creating the three-dimensional sipe.

Blade 200 may be formed using a thin sheet of material pressed into a desired shape, and generally having a material thickness that is consistent at least through radially outer zig-zag portion 201, radially inner three-dimensional portion 102, and radially inner zig-zag portion 250. Blade 200 may be formed using a thin sheet of material pressed into a desired shape, and generally having a material thickness that is not constant in radially inner three-dimensional portion 202. Base 204 may have a material thickness that is different when compared to that of radially outer zig-zag portion 201, radially inner three-dimensional portion 202, and/or radially inner zig-zag portion 250. In this manner, it is understood that a feature that is positive (i.e., extending out of blade 200 on a first side of blade 200) is negative (i.e., extending into blade 200 on a second side of blade 200). Blade 200 may be formed using any of a variety of manufacturing methods, including for example, machining, three-dimensional printing, casting, stamping, and the like, so as to produce the relationship described herein between positive elements and negative elements on exact opposite sides of blade 200. This arrangement is shared by each blade described herein.

Blade 200 may be formed from any of a variety of materials, including for example a metal (e.g., a steel or an alloy), a polymer, a ceramic, a composite, and the like. Blade 200 may be formed from a material capable of withstanding the heat and pressure associated with molding a tire.

It is understood that when molding a tire using a sipe blade, such as blade 200 (and all other blades described below), base 204 forms the base of a sipe in a tire, while radially outer zig-zag portion would form the ground-contacting radially outer portion of the sipe. Blade 200 may be affixed into a tire mold in such a manner to effect this molding orientation. As such, the term “radially outer zig-zag portion” reflects the fact that a three-dimensional sipe molded into a tire using blade 200 (and all other blades described below) would include the zig-zag feature molded by radially outer zig-zag portion 201 in a portion of the three-dimensional sipe that is oriented radially outward relative to the remainder of the three-dimensional sipe. Similarly, the term “radially inner three-dimensional portion” reflects the fact that a three-dimensional sipe molded into a tire using blade 200 (and all other blades described below) would include the three-dimensional feature molded by radially inner three-dimensional portion 202 in a portion of the three-dimensional sipe that is oriented radially inward relative to radially outer zig-zag portion 201. Finally, the term “radially inner zig-zag portion” reflects the fact that a three-dimensional sipe molded into a tire using blade 200 (and all other blades described below) would include the zig-zag feature molded by radially inner zig-zag portion 250 in a portion of the three-dimensional sipe that is oriented radially inward relative to the remainder of the three-dimensional sipe (except for base 204), and at least radially inward of both the radially outer zig-zag portion 201 and the radially inner three-dimensional portion 202.

The X, Y, and Z axes illustrated in the figures are utilized for ease of description of the invention, and are not intended as limiting. In some instances, the X-axis may be generally tangential to the circumferential direction of a tire, the Y-axis may be generally parallel to the axial direction of a tire, and the Z-axis may be generally parallel to the radial direction of a tire. In some instances, the X-axis may be exactly tangential to the circumferential direction of a tire, the Y-axis may be exactly parallel to the axial direction of a tire, and the Z-axis may be exactly parallel to the radial direction of a tire. However, sipes formed using blade 200 (and all blades described herein) are not necessarily aligned as described above, but rather, may be inclined relative to the axial, circumferential, and/or radial directions of the tire. In this sense, the X, Y, and Z axes are not limiting, but are utilized for convenience.

Blade 200 may include a plurality of positive elements 206 and a plurality of negative elements 208. Collectively, these features may form the three-dimensional feature described herein. That is, a pattern of alternating positive elements 206 and negative elements 208 may form the three-dimensional feature described as radially inner three-dimensional portion 202.

Radially inner three-dimensional portion 202 may have a height RmH. Blade 200 may have a height RH. Height RmH may be about 32% of blade radial height RH. Height RmH may be 32% of blade radial height RH. Height RmH may be about 33% of blade radial height RH. Height RmH may be 33% of blade radial height RH. Height RmH may be between about 27% and about 37% of blade radial height RH. Height RmH may be between 27% and 37% of blade radial height RH. Height RmH may be between about 22% and about 42% of blade radial height RH. Height RmH may be between 22% and 42% of blade radial height RH. A sipe molded into a tire using blade 200 will have the same relationship in heights of RH and RmH.

As illustrated further below, positive elements 206 and negative elements 208 may result in corresponding positive elements and negative elements in a three-dimensional tire sipe molded using blade 200. These corresponding positive elements and negative elements may interlock with one another so as to create stiffness in a tire tread element having the three-dimensional sipe. The corresponding features may come together along the X-axis, to provide greater shear strength in the Y-Z plane between opposing faces of a sipe, as compared to a traditional, straight wall sipe.

Radially outer zig-zag portion 201 may be formed by a series of alternating angled surfaces 210 and 212, which form radially-extending peaks 214 and valleys 216. These peaks and valleys may form corresponding peaks and valleys in a tire sipe molded using blade 200. These corresponding peaks and valleys may interlock with one another so as to create stiffness in a tire tread element having the three-dimensional sipe.

Radially outer zig-zag portion 201 may have a height RoH. Height RoH may be about 24% of blade radial height RH. Height RoH may be 24% of blade radial height RH. Height RoH may be about 23% of blade radial height RH. Height RoH may be 23% of blade radial height RH. Height RoH may be between about 20% and about 30% of blade radial height RH. Height RoH may be between 20% and 30% of blade radial height RH. Height RoH may be between about 15% and about 35% of blade radial height RH. Height RoH may be between 15% and 35% of blade radial height RH. A sipe molded into a tire using blade 200 will have the same relationship in heights of RH and RoH.

Radially inner zig-zag portion 250 may be formed by a series of alternating angled surfaces 256 and 258, which form biased, but generally radially-extending, peaks 252 and valleys 254. These peaks and valleys may form corresponding peaks and valleys in a tire sipe molded using blade 200. These corresponding peaks and valleys may interlock with one another so as to create stiffness in a tire tread element having the three-dimensional sipe.

Peaks 252 and valleys 254 may be biased from the radial direction (parallel to the Z-axis) by an angle A3. Angle A3 may be measured in reference to a centerline CL of the sipe, which centerline CL may extend radially (parallel to the Z-axis) in the corresponding tire molded using blade 200. Angle A3 may be about 15 degrees. Angle A3 may be 15 degrees. Angle A3 may be between about 14 degrees and about 16 degrees. Angle A3 may be between 14 degrees and 16 degrees. Angle A3 may be between about 12 degrees and about 18 degrees. Angle A3 may be between 12 degrees and 18 degrees.

The X-axis (generally circumferential) depth of peaks 252 and valleys 254 may gradually decrease as peaks 252 and valleys 254 extend radially inwardly toward a radial connection 205 extending between radially inner zig-zag portion 250. Stated differently, peaks 252 and valleys 254 may taper into radial connection 205 as peaks 252 and valleys 254 extend radially inwardly in the direction of base 204.

The angle A3 and tapered nature of radially inner zig-zag portion 250 yields a reduction in the undercut surface geometry (that is, the surface geometry of this section of blade 200) that is reduced by up to 37%, or exactly 37%, over the prior art designs disclosed above and illustrated in FIGS. 1A-1B. The result is that the force required to withdraw the tire tread mold from the tire tread following curing of the tire is reduced by up to 37%, or exactly 37%, over the prior art designs disclosed above and illustrated in FIGS. 1A-1B.

Peaks 252 have a distal section (defined as its greatest extent in the X-axis (generally circumferential direction) and being in the form of a ridgeline). Positive elements 206 likewise have a terminal portion (defined as its greatest extent in the X-axis (generally circumferential direction)). The distal section of peak 252 may extend further in the X-axis (generally circumferential direction) than the terminal portion of positive element 206 by an offset distance 01. Offset distance 01 may be about 20% of the distance of peak 252's distal section from centerline CL. Offset distance 01 may be between about 18% and 22% of this aforementioned distance. Offset distance 01 may be between 18% and 22% of this aforementioned distance.

Radially inner zig-zag portion 250 may have a height RiH. Height RiH may be about 44% of blade radial height RH. Height RiH may be 44% of blade radial height RH. Height RiH may be about 45% of blade radial height RH. Height RiH may be 45% of blade radial height RH. Height RiH may be between about 40% and about 50% of blade radial height RH. Height RiH may be between 40% and 50% of blade radial height RH. Height RiH may be between about 35% and about 55% of blade radial height RH. Height RiH may be between 35% and 55% of blade radial height RH. A sipe molded into a tire using blade 100 will have the same relationship in heights of RH and RiH.

Radially inner zig-zag portion 250's peaks 252 are aligned (in the Y-axis (axial direction) with radially outer zig-zag portion 201's peaks 214. Radially inner zig-zag portion 250's valleys 254 are aligned (in the Y-axis (axial direction) with radially outer zig-zag portion 201's valleys 216.

The terminal portion of each positive element 206 and each negative element 208 is aligned (in the Y-axis (axial direction) with either peaks 214, 252 or valleys 216, 254.

The terminal portion of each of the radially inner set of positive elements 206 (that is, those elements contiguous to/connecting to radially inner zig-zag portion 250) may directly connect to and form a part of peak 252, while the terminal portion of each of the radially inner set of negative elements 208 may directly connect to and form a part of valley 254.

The radially inner set of positive elements 206 (that is, those elements contiguous to/connecting to radially inner zig-zag portion 250) may form an angle A4 with contiguous (connecting) peaks 252. Angle A4 may be about 120 degrees. Angle A4 may be 120 degrees. Angle A4 may be derived using the following equation: Angle A4=180 degrees−45 degrees−angle A3.

In the prior art blade 100, the three-dimensional feature that would include the equivalent placement of angle A4 has an angle of 120 degrees.

The interlocking aspect of the features described herein (in reference to each of the three-dimensional sipes herein) may result in a tire tread sipe that has the increased surface area desired when the sipe is “open” (e.g., while running down a roadway), but may result in increased stiffness when the sipe is “closed” (e.g., under breaking or when heavy tractive forces are applied, which may result in the tread element containing the sipe to be deformed).

Each of the three-dimensional features forming the plurality of positive elements 206 and a plurality of negative elements 208 may be made up of three planar surfaces 218, 220, and 222. For the ease of description, planar surfaces 218 and 220 may be referred to as side surface 218 and side surface 220, while planar surface 222 may be referred to as top surface 222. It is understood that these terms are not intended to be limiting, but rather, are used to simply clarify the relationship between these surfaces.

Each of planar surfaces 218, 220, and 222 may be angled relative to one another by about 90 degrees. Each of planar surfaces 218, 220, and 222 may be angled relative to one another by 90 degrees. Each of planar surfaces 218, 220, and 222 may be angled relative to one another by between about 85 degrees and about 95 degrees. Each of planar surfaces 218, 220, and 222 may be angled relative to one another by between 85 degrees and 95 degrees. Each of planar surfaces 218, 220, and 222 may be angled relative to one another by between about 80 degrees and about 100 degrees. Each of planar surfaces 218, 220, and 222 may be angled relative to one another by between 80 degrees and 100 degrees. Each of planar surfaces 218, 220, and 222 may be angled relative to one another by between about 75 degrees and about 105 degrees. Each of planar surfaces 218, 220, and 222 may be angled relative to one another by between 75 degrees and 105 degrees.

In one embodiment, the point at which each of planar surfaces 218, 220, and 222 meet may be a rounded, terminal portion. The terminal portion may have a radius.

Each of planar surfaces 218, 220, and 222 may have a quadrilateral shape. One or more of planar surfaces 218, 220, and 222 may be at least one of a square, a rectangle, a rhombus, and a parallelogram. In one embodiment, each of planar surfaces 218, 220, and 222 is a square. In another embodiment, top surface 222 may be square, while side surfaces 218, 220 are rectangular.

In one embodiment, top surface 222 may have a width EW1. Top surface 222 may be square, and thus may have a width EW1 about each of its four sides. Where side surfaces 218, 220 are rectangular, side surfaces 218, 220 may also have a width EW1 about two sides, with a height being greater than or less than EW1, which will be further described below. Blade 200 may have a longitudinal width LW.

Each of the plurality of positive elements 206 and negative elements 208 may have a height EH1, EH2. Height EH1, EH2 may be equal to width EW1. Height EH1, EH2 may be less than width EW1. Height EH1, EH2 may be greater than width EW1. Height EH1, EH2 may be about 71.5% of width EW1. Height EH1, EH2 may be 71.5% of width EW1. Height EH1, EH2 may be between about 70% and about 75% of width EW1. Height EH1, EH2 may be between 70% and 75% of width EW1. Height EH1, EH2 may be between about 65% and about 80% of width EW1. Height EH1, EH2 may be between 65% and 80% of width EW1. Height EH1, EH2 may be between about 60% and about 85% of width EW1. Height EH1, EH2 may be between 60% and 85% of width EW1. A sipe molded into a tire using blade 200 will have the same relationship in heights EH1, EH2, and width EW1.

The line formed by the intersection of planar surfaces 218 and 220 may be oriented at an angle A1 relative to peak 214 (and central plane 203/centerline CL). Angle A1 may be about 45 degrees. Angle A1 may be 45 degrees. Central plane 203 and centerline CL may be coplanar. Central plane 203 is the plane of blade 200 that corresponds to centerline CL of a sipe molded using blade 200.

The line formed by the intersection of planar surfaces 218 and 220 may be oriented at an angle A2 relative to planar surface 222 (forming the top surface). Angle A2 may be about 90 degrees. Angle A2 may be 90 degrees.

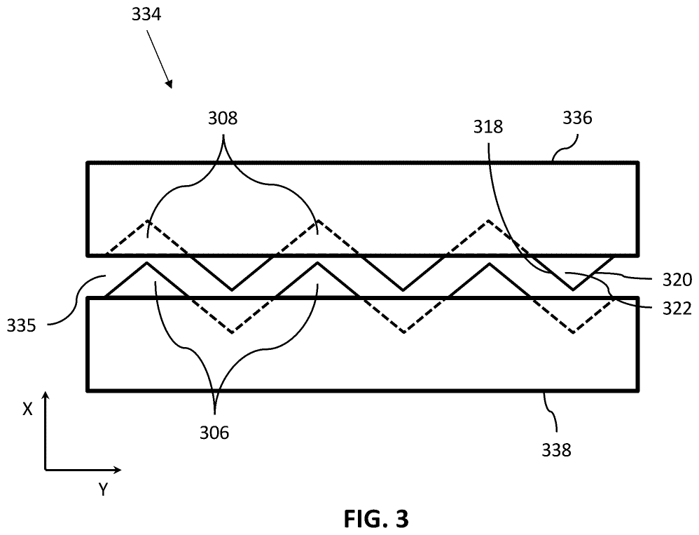

FIG. 3 illustrates a plan view of a tire tread element 334 illustrating engagement between a first and second element of a three-dimensional tire sipe. Tread element 334 may be at least partially bisected by a three-dimensional sipe 335, forming a first tread element portion 336 and a second tread element portion 338. Tread element portions 336, 338 may include a plurality of positive elements 306 and a plurality of negative elements 308.

Each of the three-dimensional features forming the plurality of positive elements 306 and a plurality of negative elements 308 may be made up of three planar surfaces 318, 320, and 322. For the ease of description, planar surfaces 318 and 320 may be referred to as side surface 318 and side surface 320, while planar surface 322 may be referred to as top surface 322. It is understood that these terms are not intended to be limiting, but rather, are used to simply clarify the relationship between these surfaces.

Each of planar surfaces 318, 320, and 322 may be angled relative to one another by about 90 degrees. Each of planar surfaces 318, 320, and 322 may be angled relative to one another by 90 degrees.

In practice, three-dimensional sipe 335 may be in contact with a running surface of a tire. When the tire is subjected to forces, tread element portions 336, 338 may extend toward one another, for example, along the X-axis, such that positive elements 306 may at least partially engage and interlock with negative elements 308, and vice versa. In this manner, three-dimensional sipe 335 may perform its function as a sipe (increasing surface area of tractive elements in a tire), while maintaining the rigidity of tread element 334. That is, the engagement of positive elements 306 with negative elements 308 may provide greater shear strength in tread element 334 in at least one of a radial direction, axial direction, and circumferential direction of the tire, as compared to a traditional, straight wall sipe.

The forces subjected to tread element portions 336, 338 that may cause interlocking thereof include forces applied to a tire when a vehicle using that tire at least one of: brakes, accelerates, and corners.

It is understood that a tire made using blade 200 would have sipes including the characteristics and features of the three-dimensional and two-dimensional elements of blade 200 but in a negative.

Additionally, tires utilizing any of the three-dimensional sipes disclosed herein may yield better performance than a tire utilizing traditional two-dimensional (straight wall) sipes in the following common tire tests: cornering coefficient, snow braking, snow acceleration, snow lateral traction, tire wear, wet roadway lap time, and dry peak friction coefficient.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11. Cartesian coordinates referenced herein are intended to comply with the SAE tire coordinate system.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A tire having a sipe, comprising:
opposing tread element portions separated by the sipe, each opposing tread element portion including a plurality of positive elements and a plurality of negative elements,
wherein the plurality of positive elements and the plurality of negative elements include three substantially quadrilateral-shaped planar surfaces, each planar surface being oriented relative to another planar surface by an angle of 90 degrees,
wherein the three planar surfaces meet at a rounded terminal portion,
wherein the sipe includes a radially outer zig-zag portion,
wherein the sipe includes a radially inner three-dimensional portion radially inward of the radially outer zig-zag portion, and
wherein the sipe includes a radially inner zig-zag portion radially inward of the radially inner three-dimensional portion.

2. The tire of claim 1, wherein the radially outer zig-zag portion includes radially-extended peaks and valleys.

3. The tire of claim 1, wherein the radially inner zig-zag portion includes radially-extended peaks and valleys.

4. The tire of claim 1, wherein the radially inner three-dimensional portion includes a first row of elements and a second row of elements.

5. The tire of claim 4, wherein the radially inner zig-zag portion includes radially-extended peaks and valleys, and wherein the terminal portion of each positive element of the second row of elements is connected to and forms a part of the radially-extended peaks of the radially inner zig-zag portion.

6. The tire of claim 3, wherein the peaks are biased from a centerline of the sipe by an angle A3, and wherein the angle A3 is 15 degrees.

7. The tire of claim 3, wherein the peaks are biased from a centerline of the sipe by an angle A3, and wherein the angle A3 is between 14 degrees and 16 degrees.

8. The tire of claim 3, wherein the peaks are biased from a centerline of the sipe by an angle A3, and wherein the angle A3 is between 12 degrees and 18 degrees.

9. The tire of claim 3, wherein the peaks and the valleys decrease in size as the peaks and valleys extend radially inwardly.

10. A tire having a sipe, comprising:
opposing tread element portions separated by the sipe, each opposing tread element portion including a plurality of positive elements and a plurality of negative elements,
wherein the plurality of positive elements and the plurality of negative elements include three substantially quadrilateral-shaped planar surfaces, each planar surface being oriented relative to another planar surface by an angle of 90 degrees,
wherein the three planar surfaces meet at a rounded terminal portion,
wherein the sipe includes a radially outer zig-zag portion,
wherein the sipe includes a radially inner three-dimensional portion radially inward of the radially outer zig-zag portion, and
wherein the sipe includes a radially inner zig-zag portion radially inward of the radially inner three-dimensional portion, the radially inner zig-zag portion including radially-extended peaks and valleys.

11. The tire of claim 10, wherein the radially outer zig-zag portion includes radially-extended peaks and valleys.

12. The tire of claim 10, wherein the radially inner three-dimensional portion includes a first row of elements and a second row of elements.

13. The tire of claim 12, wherein the radially inner zig-zag portion includes radially-extended peaks and valleys, and wherein the terminal portion of each positive element of the second row of elements is connected to and forms a part of the radially-extended peaks of the radially inner zig-zag portion.

14. The tire of claim 10, wherein the peaks are biased from a centerline of the sipe by an angle A3, and wherein the angle A3 is 15 degrees.

15. The tire of claim 10, wherein the peaks are biased from a centerline of the sipe by an angle A3, and wherein the angle A3 is between 14 degrees and 16 degrees.

16. The tire of claim 10, wherein the peaks are biased from a centerline of the sipe by an angle A3, and wherein the angle A3 is between 12 degrees and 18 degrees.

17. The tire of claim 10, wherein the peaks and the valleys decrease in size as the peaks and valleys extend radially inwardly.
